(19) United States
(12) Patent Application Publication
(10) Pub. No.: US 2016/0221266 A1
(43) Pub. Date: Aug. 4, 2016

(54) METHODS AND SYSTEMS FOR THREE DIMENSIONAL PRINTING OF AN OBJECT HAVING A TWO-PART INFILL

(71) Applicant: ipCreate Inc., Williston, VT (US)

(72) Inventor: John E. Cronin, Bonita Springs, FL (US)

(21) Appl. No.: 14/991,207

(22) Filed: Jan. 8, 2016

Related U.S. Application Data
(60) Provisional application No. 62/101,547, filed on Jan. 9, 2015.

(51) Int. Cl. B29C 67/00; G05B 19/4099

(52) U.S. Cl. CPC B29C 67/0088; B29C 67/0059; G05B 19/4099; B33Y 10/00

(57) ABSTRACT

Methods and systems for creating an object having a two-part infill that is to be manufactured using a 3D printing process. In some embodiments, the two-part infill may include a printed infill and a fluid infill that is injected into an object's shell after the shell and printed infill have been printed. Yet other embodiments include computer-aided design software having a graphical user interface configured to receive information for defining characteristics of an object having a two-part infill. Yet other embodiments include one or more 3D printers for printing an object and one or more fluid-infill installation stations for installing a fluid-infill material into the object.

### CROSS-REFERENCE TO RELATED APPLICATIONS

The present application claims the priority benefit of U.S. provisional application No. 62/101,547 filed Jan. 9, 2015 and entitled “Methods and Systems for Three Dimensional Printing of an Object Having a Two-Part Infill,” the disclosure of which is incorporated herein by reference.

### BACKGROUND

1. Field of Invention

The present invention generally relates to the field of three dimensional (3D) printing. In particular, the present invention is directed to three dimensional printing of objects with a two-part infill.

2. Description of the Related Art

The term “additive manufacturing,” also known as “3D printing,” encompasses a broad and growing category of manufacturing techniques and processes that involve manufacturing objects by the sequential delivery of energy and/or material to specified points in space to produce the object. A 3D printing process typically involves providing a 3D printer with machine instructions for printing an object. In many cases, the instructions include shell or perimeter information that defines the outer shell(s) of the object and infill information, which defines the internal structure of the object. The infill information may include information on the geometric shape(s) of the internal structure and/or the percent of the object's inner cavity that will be taken up by the infill structure, sometimes referred to as “percent infill.” For example, a hollow object has 0% infill and a completely solid object has 100% infill. The shell and infill information can have a significant impact on the manufacturing process and the characteristics of the printed object. For example, as the number of shells is increased and the percent infill is increased, the weight and strength of the object generally increase and manufacturing (printing) time and cost and amount of raw materials also increase. Thus, reducing the amount of infill and/or the number of shells can have a positive effect of reducing printing time and cost, but doing so may result in a printed object having unacceptable structural characteristics, such as unacceptably low strength, stiffness, and/or stability.

### SUMMARY OF THE DISCLOSURE

In an implementation, the present disclosure is directed to a method of generating instruction for printing an object to be printed with a 3D printer, wherein the object has a shell and a printed infill. The method includes receiving information defining the shell; receiving printed-infill parameters defining the printed infill, wherein the printed infill has a geometry; receiving fluid-infill parameters; customizing the geometry of the printed infill as a function of the fluid-infill parameters; modifying the information defining the shell as a function of the fluid-infill parameters; and generating the instructions for printing the object based on the customizing and the modifying.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a method of defining parameters for 3D printing an object having a two-part infill composed of a printed infill and a fluid infill;

FIG. 2A illustrates an exemplary 3D printed object;

FIG. 2B is a cross section of the object of FIG. 2A showing a printed infill;

FIG. 2C is a graph illustrating print time as a function of the percentage infill of a printed infill;

FIG. 3 illustrates the object of FIG. 2 with modifications according to fluid-infill parameters;

FIG. 4A and FIG. 4B are cross sections of the object model shown in FIG. 3;

FIG. 5 illustrates an exemplary fluid-infill filling station;

FIG. 6 illustrates an exemplary graphical user interface of software configured to receive instructions for and generate a two-part infill model;

FIG. 7 illustrates an exemplary software process for creating a two-part infill 3D printed object;

FIG. 8 illustrates an exemplary methods of manufacturing a two-part infill 3D printed object; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Some aspects of the present disclosure are directed to systems and methods for defining infill parameters for an object to be manufactured using an additive manufacturing or 3D printing process (hereinafter “3D printing”) to provide a two-part infill. The two-part infill may include a 3D printed infill having a geometry and percent infill printed, for example, in a layer-by-layer fashion concurrently with printing of the object's shell, and a fluid infill that is injected or otherwise inserted into voids within printed infill within the object's shell after the shell and printed infill have been printed. Such a two-part infill design may provide a variety of benefits, including significantly reducing printing time without compromising the structural properties of the manufactured object, as well as providing the ability to manufacture an object with a composite infill, wherein the structure of the printed infill may be varied and the materials used for the printed and fluid infill may be varied. These variables can provide significant degrees of freedom for optimizing printing time and cost as well as for optimizing structural characteristics of the printed object.

Aspects of the present disclosure also include computer-aided design software programs that may include graphical user interfaces configured to receive information for defining the characteristics of an object to be printed as well as, in some cases, parameters for a 3D printing process. Aspects further include one or more 3D printers configured to manufacture an object having a printed infill geometry and also configured to install a fluid-infill material into the shell of the object to form a fluid-based infill. The term “infill” as used herein may broadly refer to the make-up of the interior of a 3D printed object. In some examples, a 3D printed object may include one or more “shells” that define an outer surface of the object. The infill may include any structure or other material contained within the object's shell.

Systems and methods disclosed herein may be adapted to a variety of different 3D printing processes. For example, the term “3D printing” as it is used herein may broadly refer to a large variety of manufacturing processes also referred to as “additive manufacturing fabrication processes” and “solid freeform fabrication processes.” Thus, 3D printing refers to any one or more of the techniques in a collection of techniques for manufacturing objects by the sequential delivery of energy and/or material to specified points in space to produce that solid. 3D printing may also include or be referred to as “rapid prototyping,” “rapid manufacturing,” “layered manufacturing,” and “additive fabrication.” It will be appreciated that 3D printing is sometimes referred to as freeform manufacturing (FFF). The following are a number of typical techniques for 3D printing, though others shall not be excluded from the scope of the present invention: electron beam melting; electron beam freeform fabrication; fused deposition modeling (fused deposition modeling extrudes hot plastic through a nozzle, building up a model); laser-engineered net shaping (a laser is used to melt metal powder and deposit it on the part directly; this has the advantage that the part is fully solid and the metal alloy composition can be dynamically changed over the volume of the part); POLYJET MATRIX (jetting of multiple types of materials); selective laser sintering (selective laser sintering uses a laser to fuse powdered metal, nylon, or elastomer; additional processing is necessary to produce fully dense metal part); shape deposition manufacturing (part and support materials are deposited by a printhead and then machined to near-final shape); solid ground curing (shines a UV light on an electrostatic mask to cure a layer of photopolymers; uses solid wax for support); stereolithography (stereolithography uses a laser to cure liquid photopolymers); three-dimensional printing with inkjet-like printheads that deposit material in layers; commonly, this includes, but is not limited to, thermal phase change inkjets and photopolymer phase change inkjets); and/or robocasting (robocasting refers to depositing material from a robotically-controlled syringe or extrusion head). As discussed further below, aspects of the present disclosure may be applied to any of the manufacturing methods listed above when the method is used to manufacture a non-solid object, and wherein any infill provided may be varied to optimize print time and/or cost, as well as material type and/or structural properties.

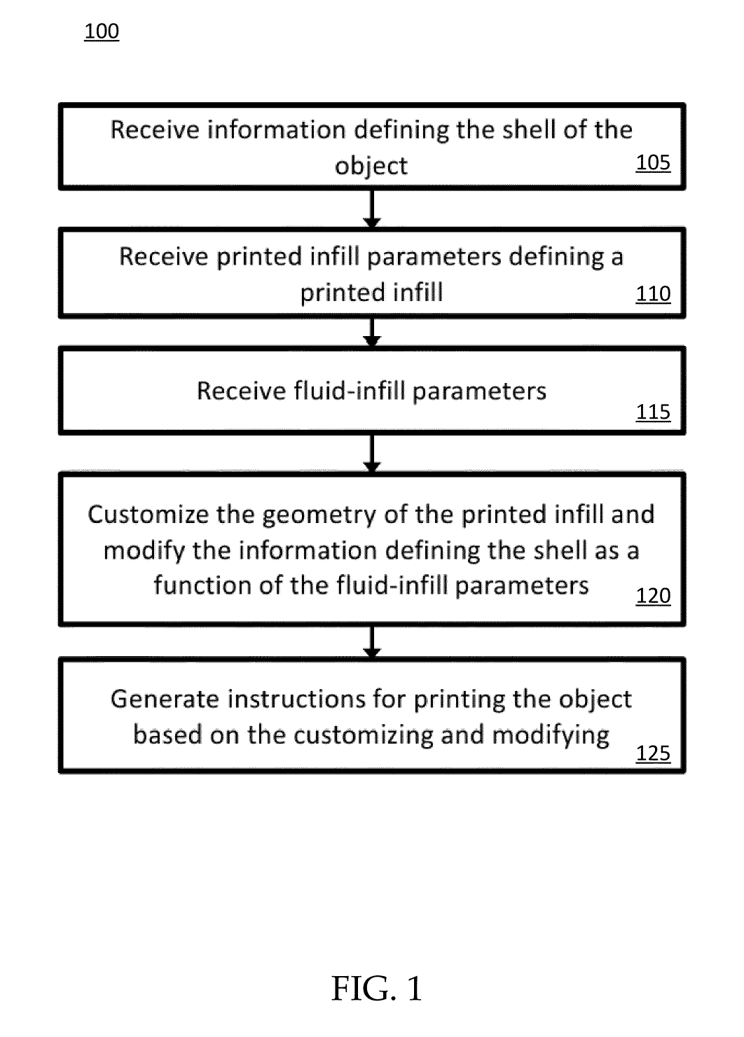

Referring now to the drawings, FIG. 1 illustrates an exemplary method 100 of defining parameters of an object to be manufactured using one or more 3D printing processes, wherein the object has a two-part infill. This method 100 may be implemented in a computer-based 3D manufacturing design software which may, for example, include a graphical user interface (GUI) configured to receive inputs from a user defining the parameters of the object to be printed. The design software may include, for example, a computer aided design (CAD) program configured to receive input and generate parameters of a three-dimensional object in any one of the variety of CAD file formats. The software may also include computer aided manufacturing (CAM) software, or alternatively, the CAD program may be configured to send information to one or more CAM software programs which may, for example, convert a CAD file defining an object into machine instructions for printing the object. The machine instructions may be provided in any one or more of a variety of formats, including a stereolithigraphic (STL) format and/or G-code, among others. The software may also include a slicing engine that may discretize the object into a series of two-dimensional layers that may be printed by a 3D printer.

As shown in FIG. 1, the exemplary method may include a step 105 of the software receiving information defining the shell of the object. The shell information may include one shell layer or may include a plurality of shell layers. As the number of shell layers is increased, the printing time and cost as well as the strength of the printed part may increase. At step 110, the software may receive printed-infill parameters defining a printed infill to be printed along with the object's shell. As discussed more fully below, printed-infill parameters may include a percent infill, as well as an infill geometry. As also discussed more below, in defining a two-part infill 3D printed object, the percent infill of the printed infill in the two-part infill object may be significantly lower than the percent infill of a single-infill object having comparable structural properties, and this can significantly reduce printing time and cost. In alternative embodiments, the software may initially receive parameters for a high-percent infill design typical of single-infill objects, and the software may then receive instructions from a user to modify the high-percent infill design to define a first infill for a two-part infill object as described more fully below.

At step 115, the software may receive fluid-infill parameters. In one example, the fluid-infill parameters may include designation, locations, and/or configuration for forming one or more infill flow passageways that allow infill fluid installed into the shell to flow through voids formed by the printed-infill structure. The fluid-infill parameters may also include information for designating, locating, and/or configuring one or more openings for forming in the shell to allow the installation of the fluid-infill material into the shell and for allowing air within the shell to be released during installation of the fluid-infill material. In step 120, the software may customize the geometry of the printed infill according to one or more of the fluid-infill parameters to form the infill flow passageways, and the software may modify the shell information to add the one or more openings for installing the fluid-infill material and add the one or more openings for allowing air to escape during the installation process. At step 125, the software may generate instructions for printing the object based on the customizing and modifying at step 120.

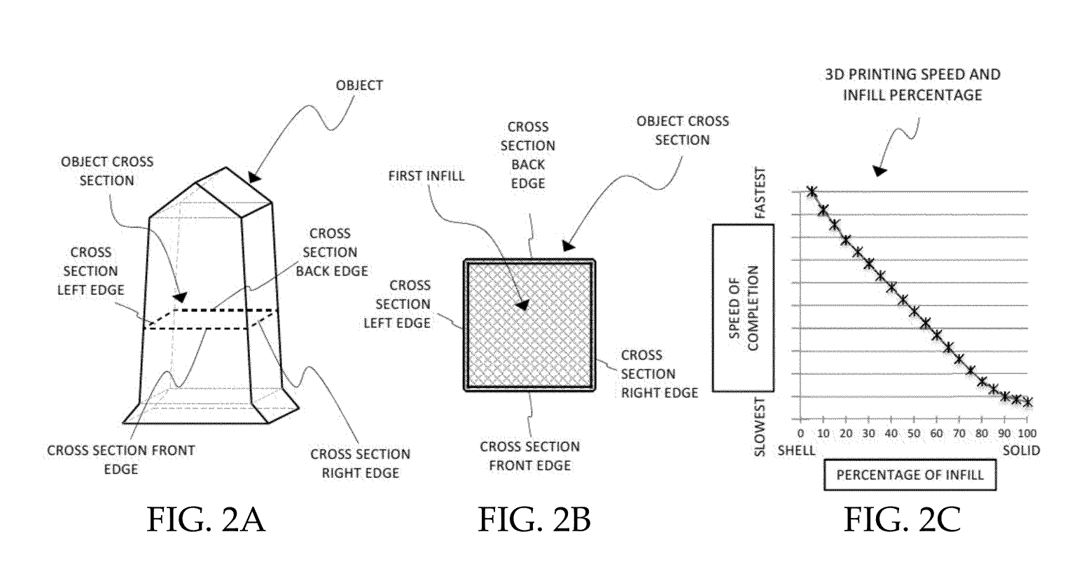

FIGS. 2-4 illustrate an exemplary application of two-part infill methods disclosed herein. FIG. 2A illustrates an exemplary 3D object to be printed with a 3D printer. FIG. 2B shows a cross section of the object and an exemplary geometry of the printed infill. In this example, the printed infill has a hexagonal pattern and a relatively high density, or percent infill, meaning a relatively large percentage of the inner cavity of the object defined by the inner wall of the shell would be filled with the printed infill if it were not modified as described below. FIG. 2C is an exemplary graph illustrating printing speed versus percent infill and showing how decreasing the percent infill can have a significant impact on printing speed.

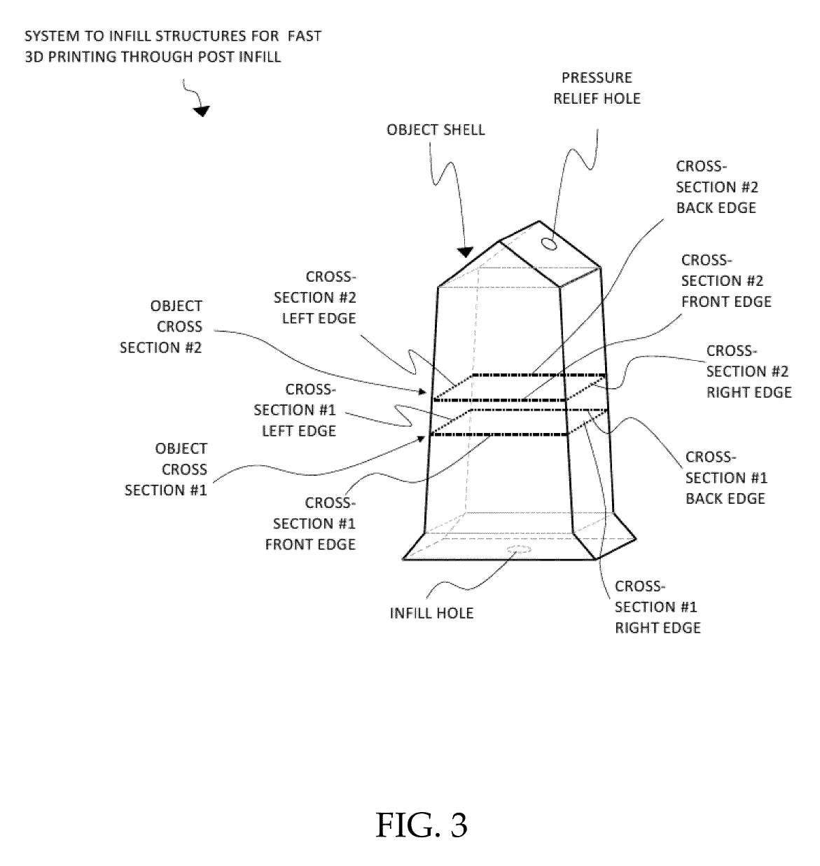

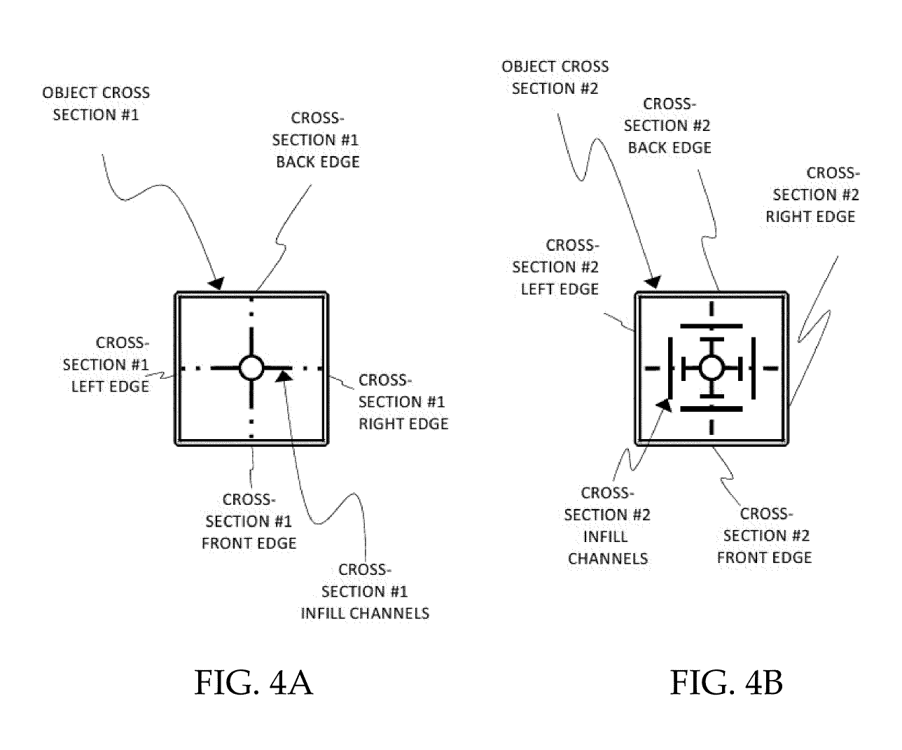

FIGS. 3, 4A, and 4B illustrate an exemplary modification of the printed infill of FIG. 2B based on fluid-infill parameters. As illustrated in FIG. 3, the fluid-infill parameters may include information for forming an infill hole and a pressure relief hole in the object shell. In this example, the infill hole is formed in the base of the shell, and the pressure relief hole is formed in the top of the shell. Also in this example, and as described more below, such an arrangement allows a fluid-infill material to be installed into the object at its base and allows air within the shell to be ejected through the pressure relief hole as the air is displaced by the fluid-infill material. Such an arrangement can provide for an infill hole that is easily concealable in the finished part. Each pressure relief hole may have a relatively small size, which generally only needs to be sufficient to allow displaced air within the shell to escape at an acceptable rate during the fluid-infill installation process. In alternative embodiments, the infill and pressure relief holes may be located in various other locations of the shell; for example, the infill hole may be in the top of the shell, which may facilitate ease of installing the second infill material, for example, using gravity. In yet other embodiments, fluid-infill parameters may define multiple infill holes located in various locations in the shell. For example, the printed and fluid infills may comprise a plurality of zones, and each zone may have a respective infill hole. In yet other examples, the second infill parameters may not include shell openings and shell openings may be formed at a different process step after 3D printing is complete, such as with a drill.

As illustrated by FIG. 4A and FIG. 4B, the fluid-infill parameters may also include information for defining or modifying the printed infill to include infill flow passageways that allow or facilitate a distributed flow of the fluid infill material throughout the interior voids within the object. In the illustrated example, the fluid-infill parameters are implemented in a layer-by-layer format. In alternative examples, the fluid-infill parameters may be implemented on a different geometric basis, and downstream CAM software and/or slicing engines may then generate 2D slices based on the 3D two-part infill geometry. As shown, both cross sections of FIGS. 4A and 4B include a central circular portion that, when combined with other cross sections, forms a substantially central inner lumen, or fluid passageway, for the fluid-infill material that facilitates the flow of the fluid-infill material from the infill hole (FIG. 3) to the top of the object. In the illustrated example, the printed-infill pattern also includes channels formed by substantially perpendicular elongate infill portions. Such channels also facilitate the even distribution of the fluid-infill material throughout the object. In alternative embodiments, the printed infill may have any of a variety of differing geometries, and the percent infill may be varied depending on an optimization of a variety of design considerations including weight, strength, printing time, and material costs. As also shown in the exemplary embodiment, the geometry of the printed infill illustrated in FIG. 4A and FIG. 4B as driven or modified by the second infill parameters has a significantly lower percent infill than the exemplary printed infill of the single-infill 3D printed object of FIG. 2B. Thus, the fluid-infill parameters, while forming fluid-infill passageways, may also allow for a significant reduction in printing time without compromising, or even improving, the structural properties of the finished object.

As illustrated by FIGS. 2-4, machine instructions for printing a 3D object may be modified from specifying a single infill design to specifying a two-part infill design by modifying or customizing a printed infill as a function of fluid-infill parameters. Such modifications/customizations may include openings in the shell of the object and modifications/customizations to the infill geometry to allow appropriate flow of the fluid-infill material used for the fluid-based infill. The machine instructions, as modified/customized, may then be processed by a 3D printer and the object shell and printed-infill as modified/customized may be printed by the 3D printer in a layer-by-layer process using any of the 3D printing processes and any one or more of a variety of materials known in the art, including the processes and materials described above. Once the object shell and printed-infill have been printed, a fluid-infill material may be installed into the shell to form a two-part infill. In one example, the fluid-infill material has a melting point temperature that is less than a melting point temperature of the material(s) used to form the shell and printed infill. The fluid-infill material may then be injected in fluid form into the shell and then allowed to solidify by cooling or curing, resulting in an object having a two-part infill made up of the printed and fluid infills. In alternative examples, the fluid infill material may be injected or poured into the shell in a solid, for example, granular form, and then formed into a solid material by, for example, the application of heat or the addition of a third material that causes the granular material to solidify or otherwise bind to inner portions of the object shell.

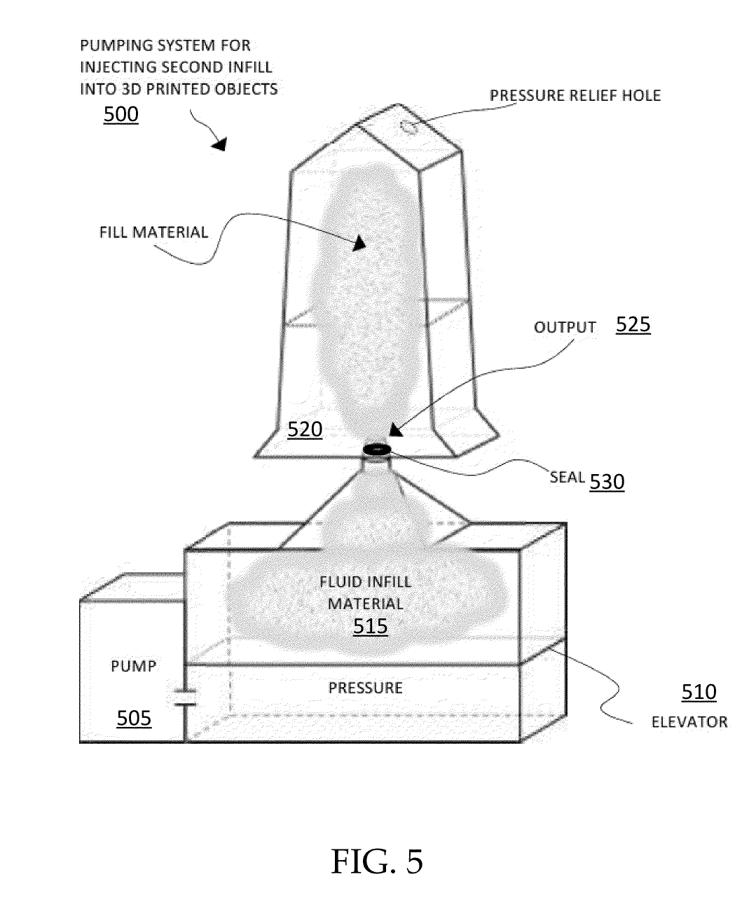

FIG. 5 illustrates an exemplary pump-based filling system 500 for installing the fluid-infill material into the object by injection. As shown in the illustrated example, the filling system 500 includes a pump 505 configured to raise an elevator 510 to thereby reduce a volume of a chamber containing the fluid-infill material 515 so as to thereby force the fluid-infill material into the object 520 via the infill hole (not shown) in the base of the object. The exemplary filling system 500 also includes an output 525 having a seal 530 configured and dimensioned to form a fluid-tight or otherwise fluidly sealed coupling with the infill hole (not shown). In the illustrated example, a filling system separate from a 3D printer is utilized to inject the fluid-infill material after the object shell and first infill structure have been printed by a 3D printer. Thus, this second infill step (second to the printing of the printed infill) may be completed by a separate downstream system, and the manufacturing time associated with the upstream 3D printer may be significantly shortened, thereby significantly increasing crucial 3D printing capacity. In alternative embodiments, the filling system may use alternative structures for creating a pressurize fluid-infill material for injecting into the object such as, for example, utilizing a screw or impeller-based design or alternative compressed gas methods. In yet other embodiments, the injection system may include a plurality of nozzles for filling a plurality of objects simultaneously, or for injecting the fluid-infill material into a single object in a plurality of locations, and further, may allow for injecting a plurality of differing fluid-infill materials into differing regions of the shell. In yet other examples and as noted above, the filing system or another component may have a hole-forming device, such as a drill, for forming the injection and pressure-relief holes, such that the 3D printer is not required to form holes in the object shell.

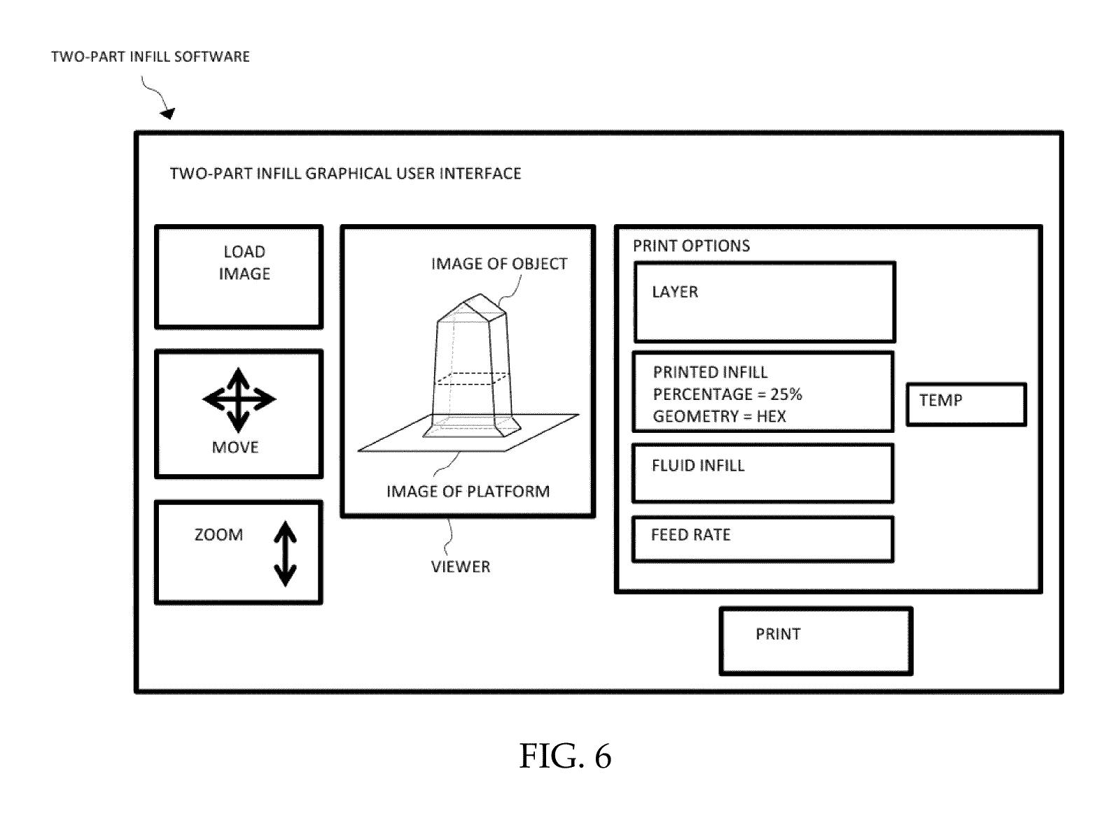

FIG. 6 illustrates software containing instructions for providing a GUI, such as the exemplary GUI of FIG. 6, which may be utilized for implementing aspects of the present disclosure. The GUI may be accessed by users directly via a website or other interface or indirectly through an external interface and may be operably connected to CAD and or CAM software for generating machine instructions for printing a 3D object. Further, the GUI may be operably connected to a system that also includes a 3D printer and optionally also includes a fluid-infill-material pumping station. Alternatively, object parameters generated by the software may be transmitted to other systems for printing the object by any means known in the art, including manual transmission of a machine-readable medium containing the object parameters or electronically over a computer network. In this way, a distributed system may be provided that, for example, allows a user to define the parameters of an object having a two-part infill and then send the parameters to, for example, a third party 3D printer for printing.

As illustrated in FIG. 6, the exemplary GUI includes a viewer and a load image button that allows a user to select an object file containing a computer representation of the object the user desires to be displayed in the viewer. In one example, the GUI may be connected to a database of object files defining objects for printing. In some examples, the user may add object files to the database, or may select from an existing file. In yet other examples, the user may directly upload an object file to the system for modification. The GUI also includes a move button and a zoom button for manipulating the view of the object shown in the viewer. The GUI may also include a print-options field that present various 3D printing options that allow the user to specify information pertaining to the printed and fluid infills. In the illustrated example, the print-options field includes a layer field which allows the user to select specific layers for specifying infill information. In alternative embodiments, the user may specify infill information in an alternative manner, and a downstream slicing engine may slice the object into a plurality of layers for printing in, for example, a G-code file format. The print options may also include a printed-infill region, which, in the illustrated example, includes a percent infill field and an infill geometry field. Print options may also include a fluid-infill region for displaying and/or specifying fluid-infill parameters for modifying/customizing the printed infill. In alternative embodiments, separate viewers and fields may be provided for specifying the fluid-infill parameters in greater detail. Print options may also include a feed rate field and a temperature field for specifying the corresponding respective operating conditions for printing the object. In the illustrated embodiment, the GUI is in communication with a 3D printer, which allows a user to select a print button to print the 3D object on the 3D printer. In alternative embodiments, the print button may generate a final object file in either a CAD or CAM file format that may then be transmitted to a remote 3D printer for printing.

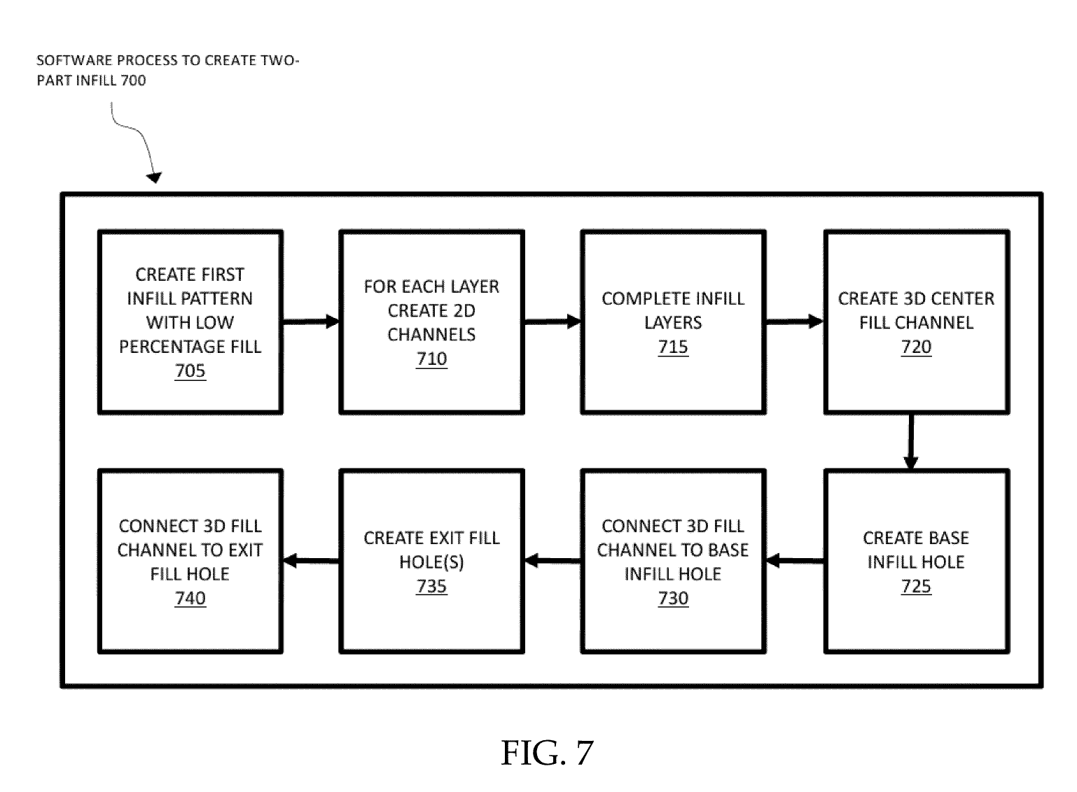

FIG. 7 illustrates an example software process for defining the parameters for fabricating a two-part-infill object having the infill design of the example object illustrated in FIG. 3, FIG. 4A, and FIG. 4B. As shown, in step 705 a printed-infill pattern with a low percentage fill is created. In this example, the object is discretized into a plurality of layers, and at step 710, 2D channels are created for each of at least some of the layers. At step 715, all of the infill layers are completed. At step 720, a 3D center fill channel, such as the inner lumen formed by a central fluid passageway as illustrated in FIG. 4, is created. At step 725 at least one infill hole, such as a base infill hole, is created, and at step 730 the 3D fill channel is connected to the base infill hole. At step 735 at least one exit fill hole in the shell is created, and at step 740 the 3D fill channel is connected to the exit fill hole. The process shown in FIG. 7 may be modified accordingly for any one of the alternative embodiments disclosed herein.

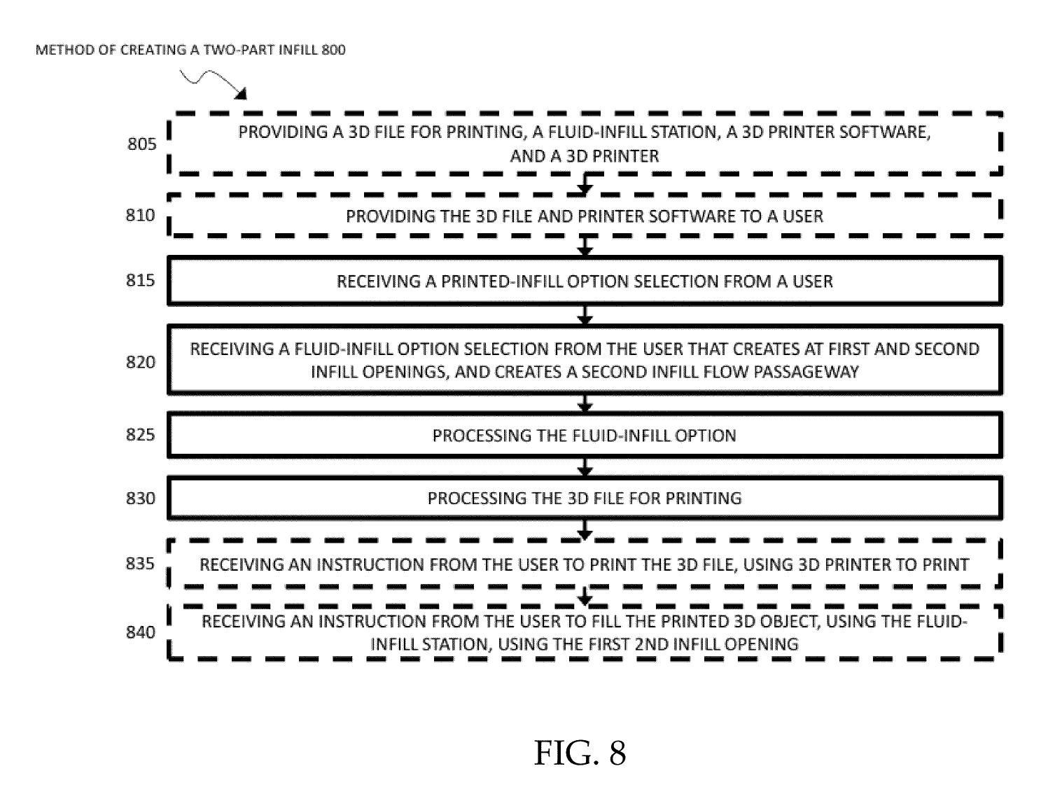

FIG. 8 illustrates an exemplary method of manufacturing a two-part-infill object using a 3D printer and separate fluid-infill station. As shown, in step 805 a 3D file may be provided to a user, as well as a 3D printer, a fluid-infill station, and 3D printer software. In alternative embodiments, only a software program for defining two-part-infill parameters may be provided and other aspects may be provided by upstream and downstream third parties. At step 810, the 3D file and software may be provided to a user. At step 815, a printed-infill option selection may be received from a user, such as the printed-infill information provided in first infill field of the GUI of FIG. 6. At step 820 fluid-infill option selections are received from the user that specify, for example, first and second infill openings in the object shell and modifications to the first infill to create fluid-infill flow passageways. At step 825, these second infill options may be processed by the software. At step 830, the object file as modified/customized may be processed for 3D printing, which may include generating machine instructions based on the modified object file. At step 835 the system may receive an instruction from the user to print the 3D file and may then use the 3D printer to print the object, and at step 840, the system may receive an instruction from the user to fill the object with a fluid-infill material, and then system may use the fluid-infill station to inject the fluid-infill material into the object.

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

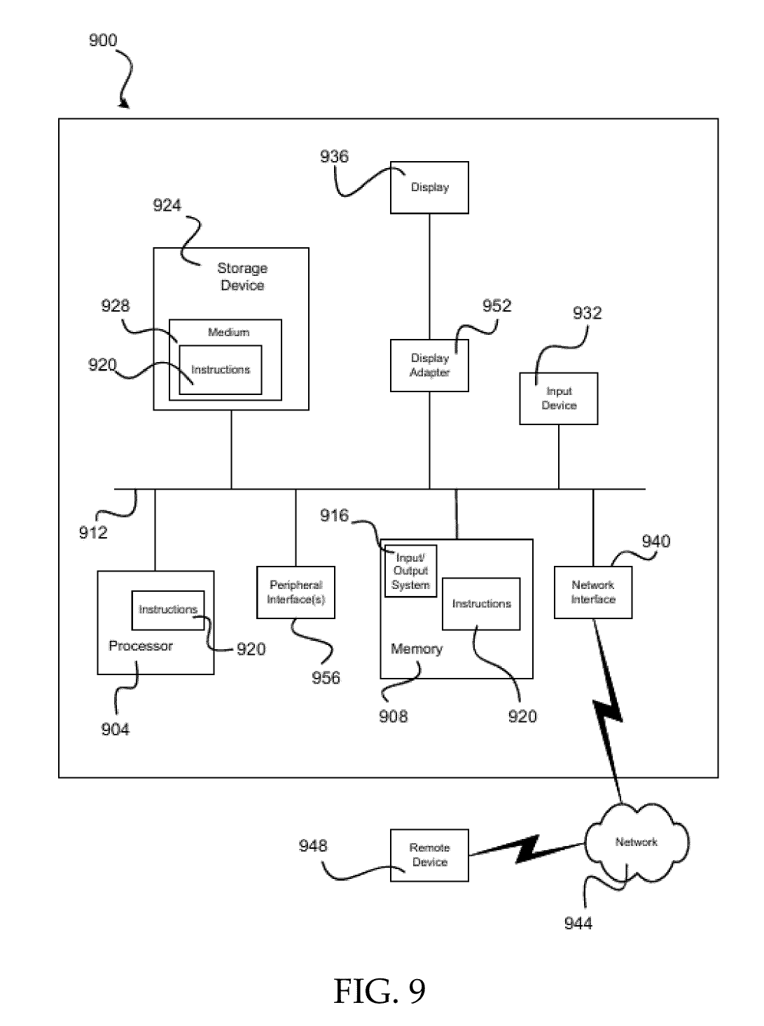

FIG. 9 shows a diagrammatic representation of one embodiment of a computing device in the exemplary form of a computer system 900 within which a set of instructions for causing a control system, such as one or more components of the CAD, CAM, 3D printing, second infill stations, and other systems disclosed herein, to perform any one or more of the aspects and/or methodologies of the present disclosure may be executed. Also, multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Memory 908 may include various components (e.g., machine readable media) including, but not limited to, a random access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of generating instruction for printing an object to be printed with a 3D printer, wherein the object has a shell and a printed infill, the method comprising:
receiving information defining the shell;
receiving printed-infill parameters defining the printed infill, wherein the printed infill has a geometry;
receiving fluid-infill parameters; and
customizing the geometry of the printed infill as a function of the fluid-infill parameters; modifying the information defining the shell as a function of the fluid-infill parameters; and generating the instructions for printing the object based on said customizing and said modifying.
